(19) United States
(12) Patent Application Publication
(10) Pub. No.: US 2019/0266483 A1
(43) Pub. Date: Aug. 29, 2019

(54) ADJUSTING A CLASSIFICATION MODEL BASED ON ADVERSARIAL PREDICTIONS

(71) Applicant: Facebook, Inc., Menlo Park, CA (US)

(72) Inventors: Umut Ozertem, San Carlos, CA (US); Christopher Kedzie, Brooklyn, NY (US)

(21) Appl. No.: 15/906,096

(22) Filed: Feb. 27, 2018

(51) Int. Cl. G06N 3/08; G06N 7/00

(52) U.S. Cl. CPC G06N 3/08; G06N 7/005

(57) ABSTRACT

This application addresses techniques to de-correlate classifiers (e.g., render them neutral) to certain target groups. Classifiers can, for example, determine the intent of content (e.g., shopping, news, etc.), flag target content, etc. Sometimes, these classification categories may be incorrectly associated with certain types, groups, characteristics, etc. Exemplary embodiments retrain a classifier's model in an adversarial manner to render it no better than chance at detecting whether content originated from an entity embodying a target type, group, characteristic, etc.

### BACKGROUND

Classifiers are used in many contexts to categorize different types of inputs. Classifiers are often created by training a model using machine learning, which analyzes characteristics of the input to learn how the characteristics correlate to different types of input. The model may then be applied to new input to determine the new input's classification. For example, classifiers have been used to classify the language of requests to determine an intent of the request, to determine whether content represents target language, to flag content, etc.

### BRIEF DESCRIPTION OF THE DRAWINGS

FIG. 1A depicts an example of classifying target language;

FIG. 1B depicts an example of an artificial neural network training a classifier model;

FIG. 2A depicts an example of an exemplary system incorporating a main classifier and an adversarial classifier;

FIG. 2B depicts the model and classifiers of FIG. 2A in more detail;

FIG. 3 depicts an exemplary data structure representing training input;

FIG. 4 is a flow chart depicting exemplary logic for performing a method according to exemplary embodiments;

FIG. 5A is a block diagram providing an overview of a system including an exemplary centralized messaging service;

FIG. 5B is a block diagram providing an overview of a system including an exemplary distributed messaging service;

FIG. 5C depicts the social networking graph of FIGS. 5A-5B in more detail;

FIG. 6 is a block diagram depicting an example of a system for a messaging service;

FIG. 7 is a block diagram illustrating an exemplary computing device suitable for use with exemplary embodiments;

FIG. 8 depicts an exemplary communication architecture; and

FIG. 9 is a block diagram depicting an exemplary multicarrier communications device.

### DETAILED DESCRIPTION

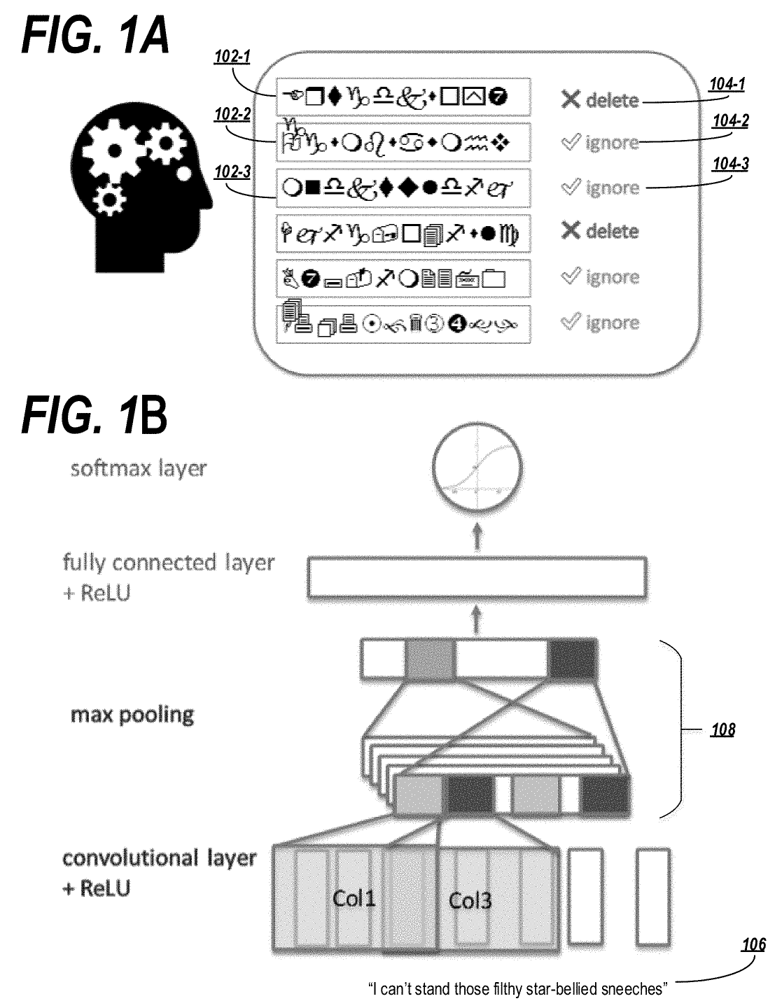

FIG. 1A shows an example of language to be classified. A user or machine may generate different instances of language usage 102-1, 102-2, 102-3, etc., and a classifier may attempt to determine whether the language in question is classified in a target classification. In this example, if the instances of language usage 102-i represent language which may or may not correspond to the target classification, the classifier may determine that the language should be removed upon a positive classification, or ignored upon a negative classification. Accordingly, each instance of language usage 102-i may be associated with a classification and/or a result 104-i indicating what should be done with the instance.

Problematically, conventional classifiers do not account for the context in which language is used. Thus, although such classifiers may learn that certain words and phrases correlate with a particular classification, the classifiers are not able to determine what causes the words and phrases to be classified as they are. In some cases, the classifier may actually begin to conflate correlation and causation, such that it learns to place language units including correlative words and phrases in the classification even when the context in which those words and phrases are used indicates that the language unit does not belong in the classification.

FIG. 1B illustrates a hypothesis as to why conventional classifiers behave in this manner. In this example, an input 106 should properly be classified as target speech, and thus is provided to a classification model as training data with a tag indicating that the language is target speech. The input 106 may include one or more words or phrases closely associated with the target categorization. The classification model in this example is an artificial neural network operable on various combinations of n-grams in the input. When provided with a sufficient number of training examples, the model begins to learn characteristics of the target classification as compared to characteristics of non-target data.

In this case, information is passed to intermediate levels 108 of the neural network, where the correlations are identified. As training data is provided and the network is adjusted, these intermediate levels 108 begin to correlate the words and phrases with a target speech classification. This is desirable behavior, since much of the speech being targeted for classification in this manner is likely to use these closely-associated words and phrases.

However, the network has no semantic understanding of the n-grams being analyzed; it merely operates on symbols for which it learns associations. Thus, the closely associated words and phrases carry no special significance to the model, except that it has been seen in many examples of the target categorization.

Some of the closely associated words and phrases may be causative of the target categorization. Others, however, may only be correlated to the target categorization without being causative. In other words, although these other words and phrases may often be present in language units categorized in the target categorization, their presence in a language unit should not cause that language unit to be so categorized (e.g., because they can just as easily or just as often be used in non-target categorizations). In the same way that the intermediate levels 108 of the model were adjusted to associate the causative closely-associated words with the target categorization, these levels may also be adjusted to correlate the other words and phrases with the target categorization. This is undesirable behavior, since these other words and phrases may often be used outside the context of target speech. Often, the context would reveal that, when originating with one target group, the likelihood that the target speech is in the targeted categorization is reduced. Even though the target speech may be correlated to the target categorization, it should not cause the system to classify sentences including this phrase as being within the target categorization.

Such correlative behavior is undesirable for several reasons. Among other problems, it demonstrates an algorithmic form of bias against certain groups correlated (but not causally linked) with a target classification. Moreover, it renders classifiers less accurate because they issue an increased number of false positives.

This application addresses techniques to de-correlate classifiers (e.g., render them neutral or nearly-neutral) to certain target categories, types, or groups. Exemplary embodiments retrain the classifier's model in an adversarial manner in an attempt to render it no better than chance at detecting whether content originated from the target group.

According to one exemplary embodiment, some or all of the following actions may be performed: (1) training a classifier model to create an original model; (2) establishing an adversarial classifier that uses the model; (3) accessing (optionally) labeled data identifying whether the data came from target groups or not; (4) requesting that the adversarial classifier determine whether the labeled data came from the target group; (5) modifying the model internals to make the adversary worse at predicting whether the labeled data came from the target group; and (6) repeating steps (4)-(5) until the adversary is no better than chance at predicting whether the labeled data came from the target group.

Put more simply, the system may train a classification model that supports two classifiers: a main classifier that classifies an input (e.g., as target speech or non-target-speech) and an adversarial classifier that attempts to predict whether the input originated with a target group or not. The adversarial classifier is supplied with input whose originator is known and the output of the main classifier when applied to the input (e.g., target speech/non-target-speech). Based on the classification and the input, the adversarial classifier uses the classification model to attempt to determine whether the input originated from the target group.

If the model correlates the target group with certain of the words and phrases in the target speech, then the adversarial classifier that relies on the model will apply this correlation and will be more likely to identify that the input originates from within the target group when the main classifier determines that the input is target speech. In this case, the adversarial classifier is said to be more “accurate” when the classifier correctly identifies the group or characteristic that originated the input. Of course, this also means that the main classifier is less accurate, or at least more inclined to false positives.

By modifying the model to decrease the accuracy of the adversarial classifier (e.g., until the adversarial classifier is not better at predicting the originator of the input than random chance), the model can be de-correlated for the group in question. At the same time, the performance of the main classifier may mostly remain intact, allowing an accurate main classifier to be maintained.

Algorithms have been deployed in a number of other contexts in which bias against an identified or unidentified group may be present. Although several examples are described herein, the present invention may be used to decorrelate any target from any characteristic within a classifier. It is also not necessary that the decorrelation be used for language-based classifiers. For example, the same technology could be used to (e.g.) improve the quality of audio or video data by identifying which artifacts are causal of poor quality and de-correlating those artifacts that are often found in low-quality audiovisual data but are not causal of low quality. These and other examples may be applied even when the target group or characteristic for which decorrelation is sought is not known a priori.

Among other applications, this technology may be used to reduce the overall number of false positives for a classification problem. For instance, this technology reduces the number of false positives when words correlating to target speech are not used in a target context. Moreover, the system is less likely to categorize something as target speech when it is, in fact, a meta-discussion of the target speech Still further, the system may become less likely to categorize language as target speech when used in a non-target context. The technology may also be used in an attempt to ensure that false positives are not raised more for certain groups than others.

These and other features of exemplary embodiments are described in more detail below. Before further discussing the exemplary embodiments, however, a general note regarding data privacy is provided.

A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

### System Architecture

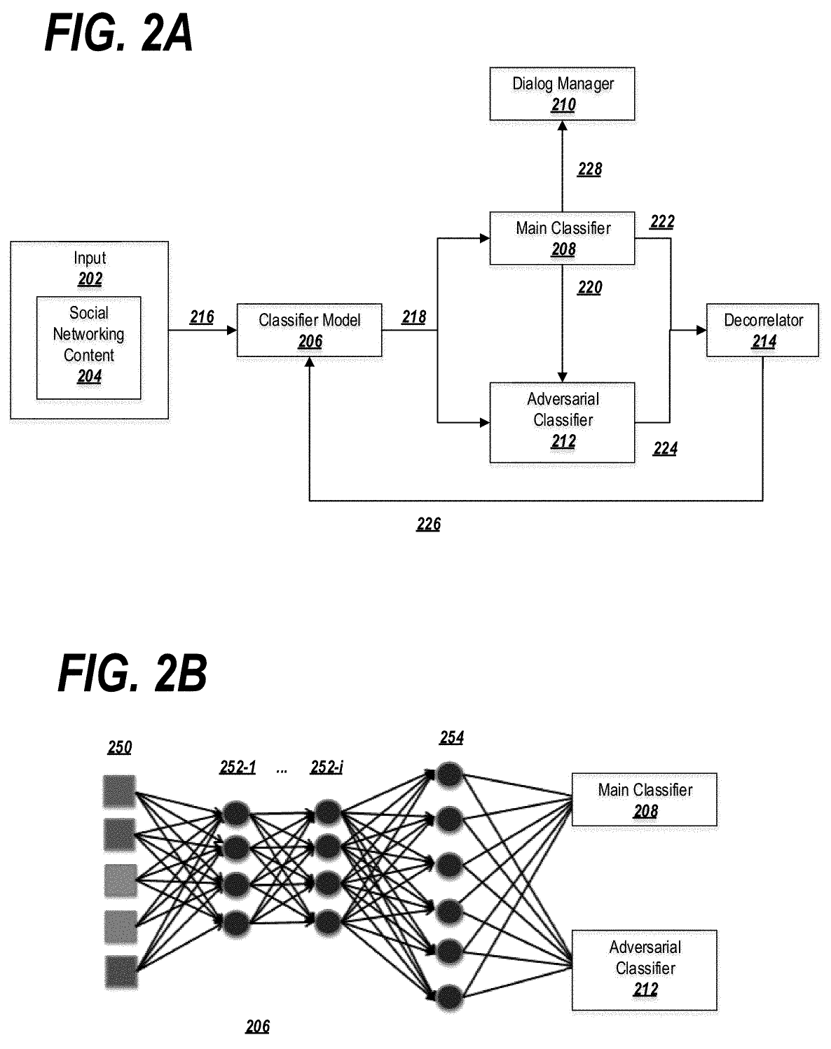

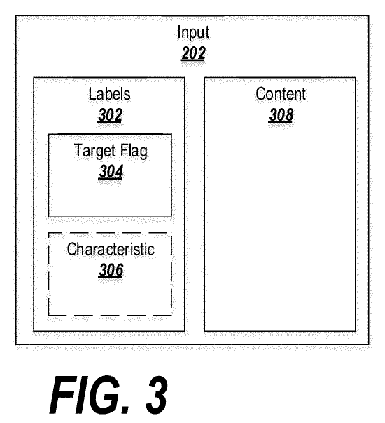

FIGS. 2A-2B depict an exemplary architecture suitable for de-correlating a classifier. A source of input 202 may be provided for training a classifier model 206 and/or for classification by the classifier model 206. When provided for training the classifier model 206, the input may include labels for training purposes, as described in more detail in connection with FIG. 3. When the input 202 is supplied for classification, the labels may or may not be present.

The input 202 may include content from a social network 204. One advantage of using social networking content 204 among the input is that training-relevant information for the above-noted labels may be more readily available in a social network than in other data (e.g., manually labeled training data). For example, it may be readily determined whether an input 202 originated from within a protected group when information about the author of the input 202 is available through the social network.

The input may be, or may include, instances of language usage. However, the present invention is not limited to classifying instances of language usage, and could equally be applied to classifying audio data, images, and/or any other category of input to which classification may be applied.

As shown in FIG. 2B, the classifier model 206 may be, for example, an artificial neural network (although other classification models may also be applied). The artificial neural network may include a number of layers, including an input layer 250 (such as a convolutional layer in the case where the neural network is a convolutional neural network), one or more intermediate layers 252-i, and an output layer 254. The final intermediate layer 252-n before the output layer may be a fully connected layer. The output layer 254 may be a softmax layer that applies a cost function. The output layer 254 may be exposed to both a main classifier 208 and an adversarial classifier 212. Thus, both the main classifier 208 and the adversarial classifier 212 may utilize the model in making classifications and predictions. A change in the model therefore should affect both the main classifier 208 and the adversarial classifier 212.

The layers of the classifier model 206 may include one or more parameters that influence the output of the model. For example, in a neural network, individual nodes may be configured to “fire” (e.g., provide a particular type of output) based on a weighted combination of inputs provided to the node. The particular connections between nodes and the weightings may represent parameters that may be adjusted in order to influence the output of the model.

A goal of adjusting the parameters of the model is to minimize the number of incorrect classifications by the main classifier 208 (i.e., so that the main classifier is discriminative of the classification target) while reducing the accuracy of the adversarial classifier 212 as close as possible to random chance (so that the adversarial classifier is indiscriminative of the target protected group).

Returning to FIG. 2A, the output of the main classifier may be provided to a dialog manager 210 which takes action based on the classification. For example, if the main classifier 208 is an intent classifier, the dialog manager 210 may interpret the identified intent and (e.g.) guide a bot or other actor to fulfill the intent. If the main classifier 208 is target language classifier, the dialog manager 210 may take action to remove the target language or flag the target language for review.

The main classifier 208 and the adversarial classifier 212 may interact with a decorrelator 214 responsible for interpreting the classifications and predictions of the classifiers and adjusting the classifier model 206 to decrease the accuracy of the adversarial classifier 212. For example, the decorrelator may identify an accuracy of the adversarial classifier 212 given a set of initial parameter settings, and then may adjust the parameters. If the accuracy of the adversarial classifier 212 decreases, similar changes may be made to other portions of the model 206, and the process may repeat. If the accuracy increases, on the other hand, the model 206 may be reverted to the original parameters (e.g., a connection between nodes that was created may be removed, or a connection that was removed may be restored), the previously-adjusted parameters may be adjusted in a different way (e.g., a weight that was increased may be decreased), and/or other parameters may be adjusted.

The decorrelator 214 may optionally also account for the accuracy of the main classifier 208. For example, if the accuracy of the main classifier 208 drops by an unacceptable amount given a certain change to the model 206 (e.g., the accuracy drops by more than a predetermined threshold amount), or the drop in accuracy to the main classifier 208 is insubstantial compared to the drop in accuracy of the adversarial classifier 212 (e.g., the accuracy of the main model 208 decreases by more than a predetermined factor or ratio as compared to the accuracy of the adversarial model 212), the decorrelator 214 may refrain from making the change.

In another example, a variety of parameters may be adjusted in different ways to generate multiple candidate models, and the one that achieves the best blend of decreasing accuracy to the adversarial classifier 212 while also minimizing the decrease (or maximizing the increase) in the accuracy of the main model 208 may be chosen for use as the classifier model 206.

In operation, an input 202 may be supplied to the classifier model 206 (pathway 216), which may process the input 202 according to the model. The results of the processing may be reflected in the final layer 254 of the model, which is exposed to both the main classifier 208 and the adversarial classifier 212 (pathway 218). The main classifier may use the output of the final layer 254 to generate a classification of the input 202, and may provide the classification to the adversarial classifier 212 (pathway 220). The adversarial classifier 212 may use the classification and the output of the final layer 254 of the model 206 to attempt to predict whether the input 202 originated from a target group or an entity having a target characteristic. In other words, the adversarial classifier 212 may be asked, based on the associations made by the model 206, whether the input 202 originated with the target group/entity given that the input 202 was classified in one way or the other by the main classifier 208.

The main classifier 208 and the adversarial classifier 212 may provide their outputs to the decorrelator 214 (paths 222 and 224, respectively). Based on a review of the outputs (potentially over a period of time or a certain number n of outputs), the decorrelator 214 may adjust the parameters of the classifier model 206 (pathway 226).

This process may repeat until a stopping condition is achieved. The stopping condition may be, for example, that the adversarial classifier 212 becomes no better than chance (or becomes suitably “bad,” by some other metric) at predicting the originator of the input. Alternatively or in addition, the stopping condition may be a precipitous drop in the accuracy of the adversarial classifier 212 (e.g., a drop in accuracy by more than a predetermined threshold amount or percentage), particularly if further changes are likely to result in smaller drops in accuracy (a plateau) while also decreasing the accuracy of the main classifier 208.

In some cases, the input 202 may include input incorrectly classified by the main classifier 208 (e.g., input that has been classified as target language by the main classifier 208, but which further review has determined not to be target language). This type of input may be especially valuable for decorrelation, because it may be possible for the model 206 or decorrelator 214 to identify words and phrases that appear in false positives and are therefore often correlated with an incorrect classification, but which are not in fact causal of the classification.

Once the classifier model 206 has been sufficiently adjusted so as to become agnostic as to the originator of the input, the classifier model 206 may be used by the main classifier 208 to classify new input. The results of the classification may be provided to the dialog manager (pathway 228).

### Data Structures

FIG. 3 depicts an example of an instance of input 202 in more detail.

The input 202 may include metadata, including labels 302. The labels 302 may identify information about the input, which may be used by the classifier model, the main classifier, the adversarial classifier and/or the decorrelator.

For example, the labels may include a target flag 304 indicating how the input should be classified (identifying, for instance, that this particular input is an example of htarget language). This information may be used to initially train the classifier model to recognize correlating characteristics in the input.

In cases where the input is being provided for classification (e.g., after the classifiers have been used to suitably train the model), some or all of the metadata may be missing from the input 202. For example, input for classification may be missing the target flag 304, and may or may not include the characteristics 306. In further instances, the target flag 304 may indicate if the input 202 is a false positive (i.e., the input 202 should not have been classified as it was by the main classifier), which may be useful for decorrelation procedures as noted above.

When the input 202 is supplied for co-training the model using the classifiers as described above, the target flag 304 may be omitted.

The labels 302 may further include one or more characteristics 306 associated with the input 202 and/or an originator of the input 202. The characteristics 306 may be used to decorrelate the classifier model with respect to those characteristics. The characteristics 306 may be provided by the originator of the input 202, may be provided by a third party, or may be derived from other information associated with the originator (e.g., from the originator's social networking profile, from information obtained from the user's social networking activity, etc.).

In some cases, it is not necessary that the target characteristics 306 actually be known in order to decorrelate the model to correlative, but not causative, properties. For example, copies of pictures may be supplied to a classifier model which are identified as “good” or “bad” examples of photography. The model may be initially trained to identify what characteristics make a good or bad photo. Based on this, the model may have the inherent assumption that, for example, certain lighting conditions cause a photograph to be classified as bad. In fact, these conditions may be correlated with poor photography but not causative of a low-quality photograph. By running the classifiers on examples of photographs and asking the adversarial classifier to predict various characteristics which might represent target characteristics, the model can be decorrelated for those characteristics that do not, in fact, cause poor quality photography. Similarly, the decorrelator could be provided with examples of false positives, which may allow decorrelation to take place without hypothesizing as to which characteristics might be target characteristics. Still further, examples of good photography could be provided to the classifier with a target flag 304, which may allow the decorrelator to identify those characteristics that are correlated to poor quality photographs but are also present in good-quality photographs.

The input 202 may further include content 308 to be classified. As noted above, the content may be language content, although the present invention is not so limited. The content 308 may include any content capable of classification by a classifier, including language data, audio data, visual data, sound data, etc.

### Exemplary Logic

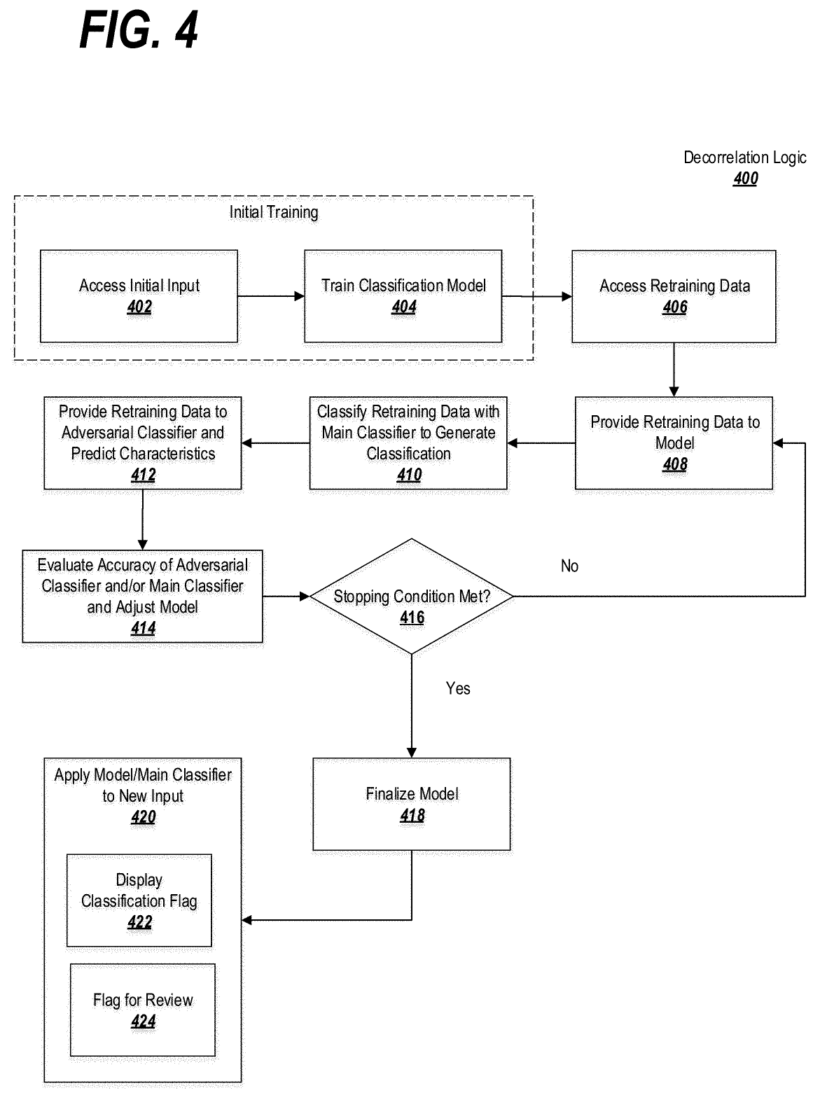

FIG. 4 depicts exemplary logic 400 suitable for use with exemplary embodiments.

At block 402, a system may access initial input for training a classification model. The training input may include content to be classified and an indicator identifying how the classifier should classify the input.

At block 404, the system may train the classification model using the initial training data. For example, a neural network may be trained based on the training data to set initial values for connections between nodes and weightings that influence whether one or more nodes provides certain outputs to other connected nodes.

At the end of block 404, a classifier model should be initially trained and ready for use in classifying new input. Blocks 402 and 404 represent an optional initial training procedure that results in a trained classifier model. However, it is not necessary that the system in question perform the initial classifier training. The invention may equally be applied to previously-trained models by accessing the models (and particularly the parameters defining the model).

At block 406, the system may access retraining data. The retraining data may be similar to the initial training data, but may optionally exclude the classification indicator and may optionally include one or more characteristics that are to be decorrelated from the model.

At block 408, the system may provide a subset of the retraining data to the model. The model may operate on the retraining data based on its current parameters and may generate an output at a final layer of the model (e.g., at a layer representing a cost function exposed to the adversarial classifier and the main classifier).

At block 410, the main classifier may classify the retraining data to generate a classification. At block 412, the classification may be provided to the adversarial classifier. The adversarial classifier may be instructed to predict whether, given the retraining data input and the results of the main classifier, the input is associated with or originated from a target group or entity having a target characteristic.

At block 414, a decorrelator may evaluate the accuracy of the adversarial classifier and/or the main classifier over the subset of input provided at block 408. The decorrelator may adjust the model's parameters based on the accuracies, as discussed above, and determine an effect of the adjustment. For example, the decorrelator may re-run the classifiers over the same retraining data or may supply new retraining data to determine if the accuracy of the adversarial classifier and/or main classifier has improved or decreased.

At block 416, the decorrelator may determine whether a stopping condition has been met. The stopping condition may be, for example, when the adversarial classifier meets a predetermined low accuracy threshold (e.g., no better than chance) in predicting the characteristics from the input. The stopping condition may also or alternatively be when the accuracy of the adversarial classifier drops by a suitably large predetermined threshold amount or ratio. Still further, the stopping condition may be that the model is retrained over a predetermined amount of retraining data, or for a predetermined amount of time.

If the answer at block 416 is “no,” processing may return to block 408 and additional retraining data may be provided to the model. If the answer is “yes,” then the system may finalize the model at block 418 and expose the model for use by classifiers.

At block 420, the system may receive a request to apply the model and/or main classifier to classify new input. The system may classify the input and may take action based on the classification. For example, at block 422, the system may classify input as it is being provided and may display a classification flag indicating that the input is likely to be classified according to the classification (e.g., “This post may be <target classification>. Are you sure you wish to proceed?”). This may allow an originator of the input to re-think the input before it is presented. In another example, at block 424 existing (or new) input may be automatically reviewed by the main classifier and evaluated to determine if it should be classified in a given manner. Classified content may then be flagged for further review and/or removed from the service.

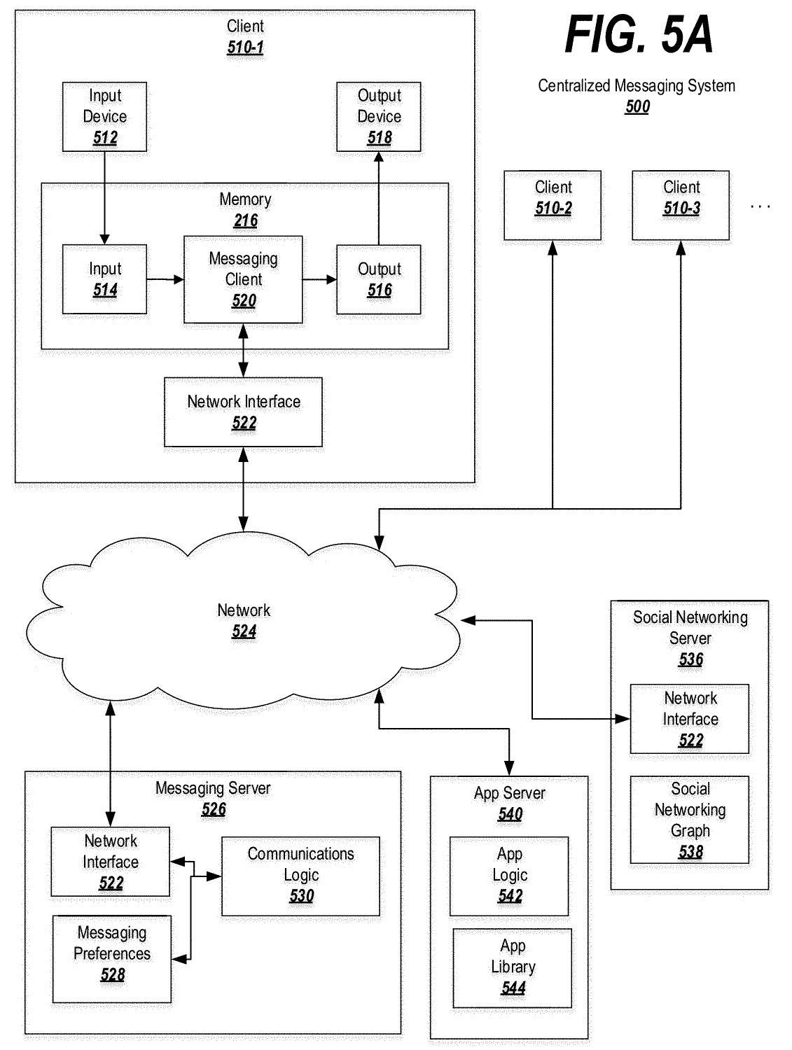

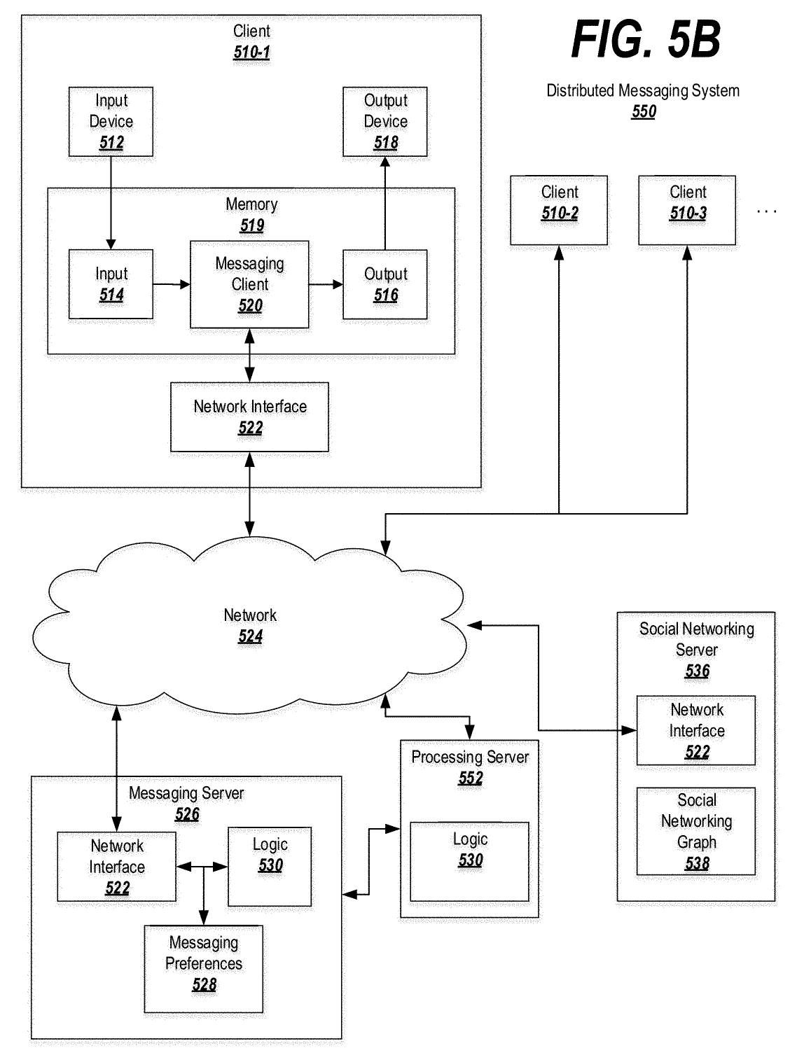

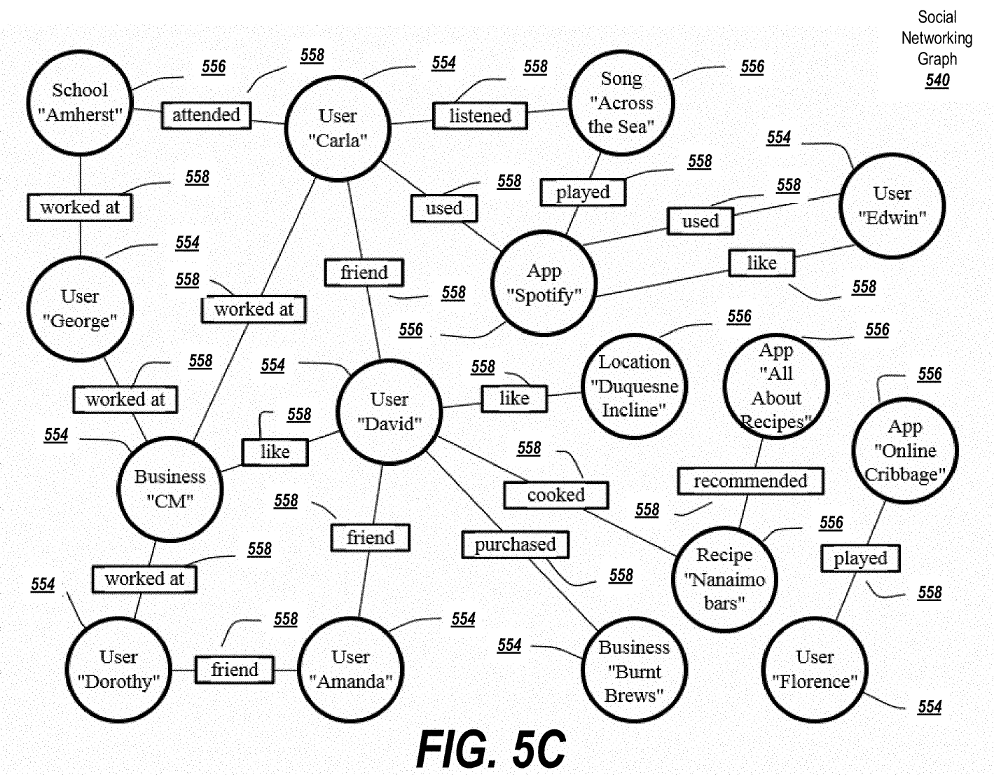

The above examples may be implemented by a messaging system that is provided either locally, at a client device, or remotely (e.g., at a remote server). FIGS. 5A-5C depict various examples of messaging systems, and are discussed in more detail below.

### Communication System Overview

FIG. 5A depicts an exemplary centralized communication system 500, in which functionality such as that descried above is integrated into a communication server. The centralized system 500 may implement some or all of the structure and/or operations of a communication service in a single computing entity, such as entirely within a single centralized server device 526.

The communication system 500 may include a computer-implemented system having software applications that include one or more components. Although the communication system 500 shown in FIG. 5A has a limited number of elements in a certain topology, the communication system 500 may include more or fewer elements in alternate topologies.

A communication service 500 may be generally arranged to receive, store, and deliver messages. The communication service 500 may store messages while clients 520, such as may execute on client devices 510, are offline and deliver the messages once the messaging clients are available. Alternatively or in addition, the clients 520 may include social networking functionality.

A client device 510 may transmit messages addressed to a recipient user, user account, or other identifier resolving to a receiving client device 510. In exemplary embodiments, each of the client devices 510 and their respective messaging clients 520 are associated with a particular user or users of the communication service 500. In some embodiments, the client devices 510 may be cellular devices such as smartphones and may be identified to the communication service 500 based on a phone number associated with each of the client devices 510. In some embodiments, each messaging client may be associated with a user account registered with the communication service 500. In general, each messaging client may be addressed through various techniques for the reception of messages. While in some embodiments the client devices 510 may be cellular devices, in other embodiments one or more of the client devices 510 may be personal computers, tablet devices, any other form of computing device.

The client 510 may include on his e or more input devices 512 and one or more output devices 518. The input devices 512 may include, for example, microphones, keyboards, cameras, electronic pens, touch screens, and other devices for receiving inputs including message data, requests, commands, user interface interactions, selections, and other types of input. The output devices 518 may include a speaker, a display device such as a monitor or touch screen, and other devices for presenting an interface to the communication system 500.

The client 510 may include a memory 519, which may be a non-transitory computer readable storage medium, such as one or a combination of a hard drive, solid state drive, flash storage, read only memory, or random access memory. The memory 519 may a representation of an input 514 and/or a representation of an output 516, as well as one or more applications. For example, the memory 519 may store a messaging client 520 and/or a social networking client that allows a user to interact with a social networking service.

The input 514 may be textual, such as in the case where the input device 212 is a keyboard. Alternatively, the input 514 may be an audio recording, such as in the case where the input device 512 is a microphone. Accordingly, the input 514 may be subjected to automatic speech recognition (ASR) logic in order to transform the audio recording to text that is processable by the communication system 500. The ASR logic may be located at the client device 510 (so that the audio recording is processed locally by the client 510 and corresponding text is transmitted to the messaging server 526), or may be located remotely at the messaging server 526 (in which case, the audio recording may be transmitted to the messaging server 526 and the messaging server 526 may process the audio into text). Other combinations are also possible—for example, if the input device 512 is a touch pad or electronic pen, the input 514 may be in the form of handwriting, which may be subjected to handwriting or optical character recognition analysis logic in order to transform the input 512 into proces sable text.

The client 510 may be provided with a network interface 522 for communicating with a network 524, such as the Internet. The network interface 522 may transmit the input 512 in a format and/or using a protocol compatible with the network 524 and may receive a corresponding output 516 from the network 524.

The network interface 522 may communicate through the network 524 to a messaging server 526. The messaging server 526 may be operative to receive, store, and forward messages between messaging clients.

The messaging server 526 may include a network interface 522, messaging preferences 528, and communications logic 530. The messaging preferences 528 may include one or more privacy settings or other preferences for one or more users and/or message threads. Furthermore, the messaging preferences 528 may include one or more settings, including default settings, for the logic described herein.

The communications logic 530 may include logic for implementing any or all of the above-described features of the present invention. Alternatively or in addition, some or all of the features may be implemented at the client 510-i, such as by being incorporated into an application such as the messaging client 520.

The network interface 522 of the client 510 and/or the messaging server 526 may also be used to communicate through the network 524 with an app server 540. The app server may store software or applications in an app library 544, representing software available for download by the client 510-i and/or the messaging server 526 (among other entities). An app in the app library 544 may fully or partially implement the embodiments described herein. Upon receiving a request to download software incorporating exemplary embodiments, app logic 542 may identify a corresponding app in the app library 544 and may provide (e.g., via a network interface) the app to the entity that requested the software.

The network interface 522 of the client 510 and/or the messaging server 526 may also be used to communicate through the network 524 with a social networking server 536. The social networking server 536 may include or may interact with a social networking graph 538 that defines connections in a social network. Furthermore, the messaging server 526 may connect to the social networking server 536 for various purposes, such as retrieving connection information, messaging history, event details, etc. from the social network.

A user of the client 510 may be an individual (human user), an entity (e.g., an enterprise, business, or third-party application), or a group (e.g., of individuals or entities) that interacts or communicates with or over the social networking server 536. The social-networking server 536 may be a network-addressable computing system hosting an online social network. The social networking server 536 may generate, store, receive, and send social-networking data, such as, for example, user-profile data, concept-profile data, social-graph information, or other suitable data related to the online social network. The social networking server 536 may be accessed by the other components of the network environment either directly or via the network 524.

The social networking server 536 may include an authorization server (or other suitable component(s)) that allows users to opt in to or opt out of having their actions logged by social-networking server 536 or shared with other systems (e.g., third-party systems, such as the messaging server 526), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking server 536 through blocking, data hashing, anonymization, or other suitable techniques as appropriate.

More specifically, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums).

In particular embodiments, privacy settings may be associated with particular elements of the social networking graph 538. Privacy settings of a social-graph element, such as a node or an edge, may specify how the social-graph element, information associated with the social-graph element, or content objects associated with the social-graph element can be accessed using the online social network. As an example and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by social networking server 536 or shared with other systems. In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In response to a request from a user (or other entity) for a particular object stored in a data store, the social networking server 536 may send a request to the data store for the object. The request may identify the user associated with the request. The requested data object may only be sent to the user (or a client system 510 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results.

In some embodiments, targeting criteria may be used to identify users of the social network for various purposes. Targeting criteria used to identify and target users may include explicit, stated user interests on social-networking server 536 or explicit connections of a user to a node, object, entity, brand, or page on social networking server 536. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also implicate privacy settings (such as user opt-outs), data hashing, or data anonymization, as appropriate.

The centralized embodiment depicted in FIG. 5A may be well-suited to deployment as a new system or as an upgrade to an existing system, because the logic for implementing exemplary embodiments is incorporated into the messaging server 526. In contrast, FIG. 5B depicts an exemplary distributed messaging system 550, in which functionality for implementing exemplary embodiments is distributed and remotely accessible from the messaging server. Examples of a distributed system 550 include a client-server architecture, a 3-tier architecture, an N-tier architecture, a tightly-coupled or clustered architecture, a peer-to-peer architecture, a master-slave architecture, a shared database architecture, and other types of distributed systems.

Many of the components depicted in FIG. 5B are identical to those in FIG. 5A, and a description of these elements is not repeated here for the sake of brevity (the app server 540 is omitted from the Figure for ease of discussion, although it is understood that this embodiment may also employ an app server 540). The primary difference between the centralized embodiment and the distributed embodiment is the addition of a processing server 552, which hosts the logic 530 for implementing exemplary embodiments. The processing server 552 may be distinct from the messaging server 526 but may communicate with the messaging server 526, either directly or through the network 524, to provide the functionality of the logic 530 to the messaging server 526.

The embodiment depicted in FIG. 5B may be particularly well suited to allow exemplary embodiments to be deployed alongside existing messaging systems, for example when it is difficult or undesirable to replace an existing messaging server. Additionally, in some cases the messaging server 526 may have limited resources (e.g. processing or memory resources) that limit or preclude the addition of the additional pivot functionality. In such situations, the capabilities described herein may still be provided through the separate bot processing server 552.

In still further embodiments, the logic 530 may be provided locally at the client 510-i, for example as part of the messaging client 520. In these embodiments, each client 510-i makes its own determination as to which messages belong to which thread, and how to update the display and issue notifications. As a result, different clients 510-i may display the same conversation differently, depending on local settings (for example, the same messages may be assigned to different threads, or similar threads may have different parents or highlights).

FIG. 5C illustrates an example of a social networking graph 538. In exemplary embodiments, a social networking service may store one or more social graphs 538 in one or more data stores as a social graph data structure via the social networking service.

The social graph 538 may include multiple nodes, such as user nodes 554 and concept nodes 556. The social graph 228 may furthermore include edges 558 connecting the nodes. The nodes and edges of social graph 228 may be stored as data objects, for example, in a data store (such as a social-graph database). Such a data store may include one or more searchable or queryable indexes of nodes or edges of social graph 228.

The social graph 538 may be accessed by a social-networking server 226, client system 210, third-party system (e.g., the translation server 224), or any other approved system or device for suitable applications.

A user node 554 may correspond to a user of the social-networking system. A user may be an individual (human user), an entity (e.g., an enterprise, business, or third-party application), or a group (e.g., of individuals or entities) that interacts or communicates with or over the social-networking system. In exemplary embodiments, when a user registers for an account with the social-networking system, the social-networking system may create a user node 554 corresponding to the user, and store the user node 30 in one or more data stores. Users and user nodes 554 described herein may, where appropriate, refer to registered users and user nodes 554 associated with registered users. In addition or as an alternative, users and user nodes 554 described herein may, where appropriate, refer to users that have not registered with the social-networking system. In particular embodiments, a user node 554 may be associated with information provided by a user or information gathered by various systems, including the social-networking system. As an example and not by way of limitation, a user may provide their name, profile picture, contact information, birth date, sex, marital status, family status, employment, education background, preferences, interests, or other demographic information. In particular embodiments, a user node 554 may be associated with one or more data objects corresponding to information associated with a user. In particular embodiments, a user node 554 may correspond to one or more webpages. A user node 554 may be associated with a unique user identifier for the user in the social-networking system.

In particular embodiments, a concept node 556 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking system or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 556 may be associated with information of a concept provided by a user or information gathered by various systems, including the social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 556 may be associated with one or more data objects corresponding to information associated with concept node 556. In particular embodiments, a concept node 556 may correspond to one or more webpages.

In particular embodiments, a node in social graph 538 may represent or be represented by a webpage (which may be referred to as a “profile page”). Profile pages may be hosted by or accessible to the social-networking system. Profile pages may also be hosted on third-party websites associated with a third-party server. As an example and not by way of limitation, a profile page corresponding to a particular external webpage may be the particular external webpage and the profile page may correspond to a particular concept node 556. Profile pages may be viewable by all or a selected subset of other users. As an example and not by way of limitation, a user node 554 may have a corresponding user-profile page in which the corresponding user may add content, make declarations, or otherwise express himself or herself. A business page such as business page 205 may comprise a user-profile page for a commerce entity. As another example and not by way of limitation, a concept node 556 may have a corresponding concept-profile page in which one or more users may add content, make declarations, or express themselves, particularly in relation to the concept corresponding to concept node 556.

In particular embodiments, a concept node 556 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system a message indicating the user's action. In response to the message, the social-networking system may create an edge (e.g., an “eat” edge) between a user node 554 corresponding to the user and a concept node 556 corresponding to the third-party webpage or resource and store edge 558 in one or more data stores.

In particular embodiments, a pair of nodes in social graph 538 may be connected to each other by one or more edges 558. An edge 558 connecting a pair of nodes may represent a relationship between the pair of nodes. In particular embodiments, an edge 558 may include or represent one or more data objects or attributes corresponding to the relationship between a pair of nodes. As an example and not by way of limitation, a first user may indicate that a second user is a “friend” of the first user. In response to this indication, the social-networking system may send a “friend request” to the second user. If the second user confirms the “friend request,” the social-networking system may create an edge 558 connecting the first user's user node 554 to the second user's user node 554 in social graph 538 and store edge 558 as social-graph information in one or more data stores. In the example of FIG. 5C, social graph 538 includes an edge 558 indicating a friend relation between user nodes 554 of user “Amanda” and user “Dorothy.” Although this disclosure describes or illustrates particular edges 558 with particular attributes connecting particular user nodes 554, this disclosure contemplates any suitable edges 558 with any suitable attributes connecting user nodes 554. As an example and not by way of limitation, an edge 558 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 538 by one or more edges 558.

In particular embodiments, an edge 558 between a user node 554 and a concept node 556 may represent a particular action or activity performed by a user associated with user node 554 toward a concept associated with a concept node 556. As an example and not by way of limitation, as illustrated in FIG. 5C, a user may “like,” “attended,” “played,” “listened,” “cooked,” “worked at,” or “watched” a concept, each of which may correspond to a edge type or subtype. A concept-profile page corresponding to a concept node 556 may include, for example, a selectable “check in” icon (such as, for example, a clickable “check in” icon) or a selectable “add to favorites” icon. Similarly, after a user clicks these icons, the social-networking system may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking system may create a “listened” edge 558 and a “used” edge (as illustrated in FIG. 5C) between user nodes 554 corresponding to the user and concept nodes 556 corresponding to the song and application to indicate that the user listened to the song and used the application. Moreover, the social-networking system may create a “played” edge 558 (as illustrated in FIG. 5C) between concept nodes 556 corresponding to the song and the application to indicate that the particular song was played by the particular application. In this case, “played” edge 558 corresponds to an action performed by an external application (SPOTIFY) on an external audio file (the song “Across the Sea”). Although this disclosure describes particular edges 558 with particular attributes connecting user nodes 554 and concept nodes 556, this disclosure contemplates any suitable edges 558 with any suitable attributes connecting user nodes 554 and concept nodes 556. Moreover, although this disclosure describes edges between a user node 554 and a concept node 556 representing a single relationship, this disclosure contemplates edges between a user node 554 and a concept node 556 representing one or more relationships. As an example and not by way of limitation, an edge 558 may represent both that a user likes and has used at a particular concept. Alternatively, another edge 558 may represent each type of relationship (or multiples of a single relationship) between a user node 554 and a concept node 556 (as illustrated in FIG. 5C between user node 554 for user “Edwin” and concept node 556 for “SPOTIFY”).

In particular embodiments, the social-networking system may create an edge 558 between a user node 554 and a concept node 556 in social graph 538. As an example and not by way of limitation, a user viewing a concept-profile page (such as, for example, by using a web browser or a special-purpose application hosted by the user's client system) may indicate that he or she likes the concept represented by the concept node 556 by clicking or selecting a “Like” icon, which may cause the user's client system to send to the social-networking system a message indicating the user's liking of the concept associated with the concept-profile page. In response to the message, the social-networking system may create an edge 558 between user node 554 associated with the user and concept node 556, as illustrated by “like” edge 558 between the user and concept node 556. In particular embodiments, the social-networking system may store an edge 558 in one or more data stores. In particular embodiments, an edge 558 may be automatically formed by the social-networking system in response to a particular user action. As an example and not by way of limitation, if a first user uploads a picture, watches a movie, or listens to a song, an edge 558 may be formed between user node 554 corresponding to the first user and concept nodes 556 corresponding to those concepts. Although this disclosure describes forming particular edges 558 in particular manners, this disclosure contemplates forming any suitable edges 558 in any suitable manner.

The social graph 538 may further comprise a plurality of product nodes. Product nodes may represent particular products that may be associated with a particular business. A business may provide a product catalog to a consumer-to-business service and the consumer-to-business service may therefore represent each of the products within the product in the social graph 538 with each product being in a distinct product node. A product node may comprise information relating to the product, such as pricing information, descriptive information, manufacturer information, availability information, and other relevant information. For example, each of the items on a menu for a restaurant may be represented within the social graph 538 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 538. The information for a product node may be manipulated by the social-networking system as a product object that encapsulates information regarding the referenced product.

As such, the social graph 538 may be used to infer shared interests, shared experiences, or other shared or common attributes of two or more users of a social-networking system. For instance, two or more users each having an edge to a common business, product, media item, institution, or other entity represented in the social graph 538 may indicate a shared relationship with that entity, which may be used to suggest customization of a use of a social-networking system, including a messaging system, for one or more users.

Messaging Architecture

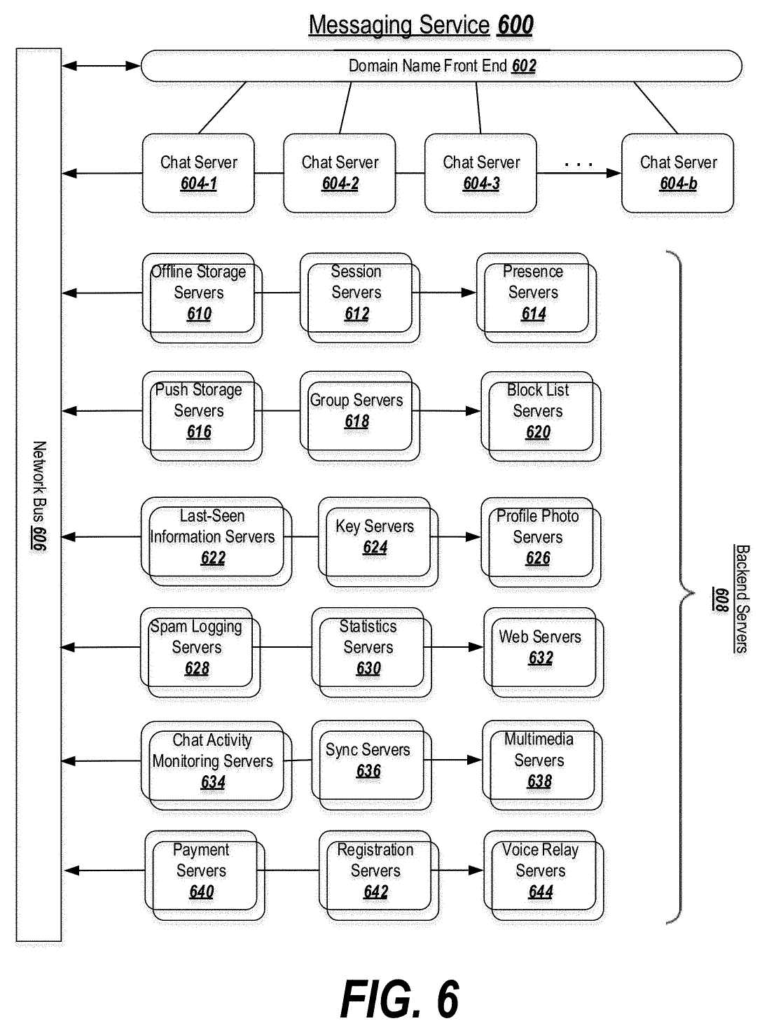

FIG. 6 illustrates an embodiment of a plurality of servers implementing various functions of a messaging service 600. It will be appreciated that different distributions of work and functions may be used in various embodiments of a messaging service 600.

The messaging service 600 may comprise a domain name front end 602. The domain name front end 602 may be assigned one or more domain names associated with the messaging service 600 in a domain name system (DNS). The domain name front end 602 may receive incoming connections and distribute the connections to servers providing various messaging services.

The messaging service 602 may comprise one or more chat servers 604. The chat servers 604 may comprise front-end servers for receiving and transmitting user-to-user messaging updates such as chat messages. Incoming connections may be assigned to the chat servers 604 by the domain name front end 602 based on workload balancing.

The messaging service 600 may comprise backend servers 608. The backend servers 608 may perform specialized tasks in the support of the chat operations of the front-end chat servers 604. A plurality of different types of backend servers 608 may be used. It will be appreciated that the assignment of types of tasks to different backend serves 608 may vary in different embodiments. In some embodiments some of the back-end services provided by dedicated servers may be combined onto a single server or a set of servers each performing multiple tasks divided between different servers in the embodiment described herein. Similarly, in some embodiments tasks of some of dedicated back-end servers described herein may be divided between different servers of different server groups.

The messaging service 600 may comprise one or more offline storage servers 610. The one or more offline storage servers 610 may store messaging content for currently-offline messaging clients in hold for when the messaging clients reconnect.

The messaging service 600 may comprise one or more sessions servers 612. The one or more session servers 612 may maintain session state of connected messaging clients.

The messaging service 600 may comprise one or more presence servers 614. The one or more presence servers 614 may maintain presence information for the messaging service 600. Presence information may correspond to user-specific information indicating whether or not a given user has an online messaging client and is available for chatting, has an online messaging client but is currently away from it, does not have an online messaging client, and any other presence state.

The messaging service 600 may comprise one or more push storage servers 616. The one or more push storage servers 616 may cache push requests and transmit the push requests to messaging clients. Push requests may be used to wake messaging clients, to notify messaging clients that a messaging update is available, and to otherwise perform server-side-driven interactions with messaging clients.

The messaging service 600 may comprise one or more group servers 618. The one or more group servers 618 may maintain lists of groups, add users to groups, remove users from groups, and perform the reception, caching, and forwarding of group chat messages.

The messaging service 600 may comprise one or more block list servers 620. The one or more block list servers 620 may maintain user-specific block lists, the user-specific incoming-block lists indicating for each user the one or more other users that are forbidden from transmitting messages to that user. Alternatively or additionally, the one or more block list servers 620 may maintain user-specific outgoing-block lists indicating for each user the one or more other users that that user is forbidden from transmitting messages to. It will be appreciated that incoming-block lists and outgoing-block lists may be stored in combination in, for example, a database, with the incoming-block lists and outgoing-block lists representing different views of a same repository of block information.

The messaging service 600 may comprise one or more last seen information servers 622. The one or more last seen information servers 622 may receive, store, and maintain information indicating the last seen location, status, messaging client, and other elements of a user's last seen connection to the messaging service 600.

The messaging service 600 may comprise one or more key servers 624. The one or more key servers may host public keys for public/private key encrypted communication.

The messaging service 600 may comprise one or more profile photo servers 626. The one or more profile photo servers 626 may store and make available for retrieval profile photos for the plurality of users of the messaging service 600.

The messaging service 600 may comprise one or more spam logging servers 628. The one or more spam logging servers 628 may log known and suspected spam (e.g., unwanted messages, particularly those of a promotional nature). The one or more spam logging servers 628 may be operative to analyze messages to determine whether they are spam and to perform punitive measures, in some embodiments, against suspected spammers (users that send spam messages).

The messaging service 600 may comprise one or more statistics servers 630. The one or more statistics servers may compile and store statistics information related to the operation of the messaging service 600 and the behavior of the users of the messaging service 600.

The messaging service 600 may comprise one or more web servers 632. The one or more web servers 632 may engage in hypertext transport protocol (HTTP) and hypertext transport protocol secure (HTTPS) connections with web browsers.

The messaging service 600 may comprise one or more chat activity monitoring servers 634. The one or more chat activity monitoring servers 634 may monitor the chats of users to determine unauthorized or discouraged behavior by the users of the messaging service 600. The one or more chat activity monitoring servers 634 may work in cooperation with the spam logging servers 628 and block list servers 620, with the one or more chat activity monitoring servers 634 identifying spam or other discouraged behavior and providing spam information to the spam logging servers 628 and blocking information, where appropriate to the block list servers 620.

The messaging service 600 may comprise one or more sync servers 636. The one or more sync servers 636 may sync the communication system 500 with contact information from a messaging client, such as an address book on a mobile phone, to determine contacts for a user in the messaging service 600.

The messaging service 600 may comprise one or more multimedia servers 638. The one or more multimedia servers may store multimedia (e.g., images, video, audio) in transit between messaging clients, multimedia cached for offline endpoints, and may perform transcoding of multimedia.

The messaging service 600 may comprise one or more payment servers 640. The one or more payment servers 640 may process payments from users. The one or more payment servers 640 may connect to external third-party servers for the performance of payments.

The messaging service 600 may comprise one or more registration servers 642. The one or more registration servers 642 may register new users of the messaging service 600.

The messaging service 600 may comprise one or more voice relay servers 644. The one or more voice relay servers 644 may relay voice-over-internet-protocol (VoIP) voice communication between messaging clients for the performance of VoIP calls.

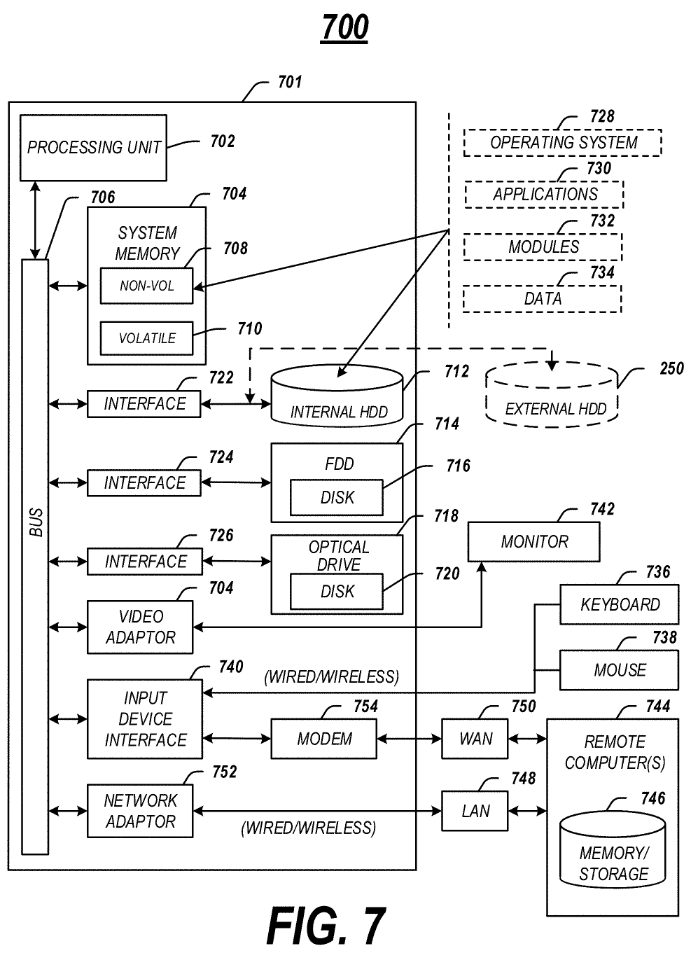

The above-described methods may be embodied as instructions on a computer readable medium or as part of a computing architecture. FIG. 7 illustrates an embodiment of an exemplary computing architecture 700 suitable for implementing various embodiments as previously described. In one embodiment, the computing architecture 700 may comprise or be implemented as part of an electronic device, such as a computer 701. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 702, a system memory 704 and a system bus 706. The processing unit 702 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 702.

The system bus 706 provides an interface for system components including, but not limited to, the system memory 704 to the processing unit 702. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile memory 708 and/or volatile memory 710. A basic input/output system (BIOS) can be stored in the non-volatile memory 708.

The computing architecture 700 may include various types of computer-readable storage media in the form of one or more lower speed memory units, including an internal (or external) hard disk drive (HDD) 712, a magnetic floppy disk drive (FDD) 714 to read from or write to a removable magnetic disk 716, and an optical disk drive 718 to read from or write to a removable optical disk 720 (e.g., a CD-ROM or DVD). The HDD 712, FDD 714 and optical disk drive 720 can be connected to the system bus 706 by an HDD interface 722, an FDD interface 724 and an optical drive interface 726, respectively. The HDD interface 722 for external drive implementations can include at least one or both of Universal Serial Bus (USB) and IEEE 694 interface technologies.

The drives and associated computer-readable media provide volatile and/or nonvolatile storage of data, data structures, computer-executable instructions, and so forth. For example, a number of program modules can be stored in the drives and memory units 708, 712, including an operating system 728, one or more application programs 730, other program modules 732, and program data 734. In one embodiment, the one or more application programs 730, other program modules 732, and program data 734 can include, for example, the various applications and/or components of the communication system 500.

A user can enter commands and information into the computer 701 through one or more wire/wireless input devices, for example, a keyboard 736 and a pointing device, such as a mouse 738. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 702 through an input device interface 740 that is coupled to the system bus 706, but can be connected by other interfaces such as a parallel port, IEEE 694 serial port, a game port, a USB port, an IR interface, and so forth.

A monitor 742 or other type of display device is also connected to the system bus 706 via an interface, such as a video adaptor 744. The monitor 742 may be internal or external to the computer 701. In addition to the monitor 742, a computer typically includes other peripheral output devices, such as speakers, printers, and so forth.

The computer 701 may operate in a networked environment using logical connections via wire and/or wireless communications to one or more remote computers, such as a remote computer 744. The remote computer 744 can be a workstation, a server computer, a router, a personal computer, portable computer, microprocessor-based entertainment appliance, a peer device or other common network node, and typically includes many or all of the elements described relative to the computer 701, although, for purposes of brevity, only a memory/storage device 746 is illustrated. The logical connections depicted include wire/wireless connectivity to a local area network (LAN) 748 and/or larger networks, for example, a wide area network (WAN) 750. Such LAN and WAN networking environments are commonplace in offices and companies, and facilitate enterprise-wide computer networks, such as intranets, all of which may connect to a global communications network, for example, the Internet.

When used in a LAN networking environment, the computer 701 is connected to the LAN 748 through a wire and/or wireless communication network interface or adaptor 752. The adaptor 752 can facilitate wire and/or wireless communications to the LAN 748, which may also include a wireless access point disposed thereon for communicating with the wireless functionality of the adaptor 752.

When used in a WAN networking environment, the computer 701 can include a modem 754, or is connected to a communications server on the WAN 750, or has other means for establishing communications over the WAN 750, such as by way of the Internet. The modem 754, which can be internal or external and a wire and/or wireless device, connects to the system bus 706 via the input device interface 740. In a networked environment, program modules depicted relative to the computer 701, or portions thereof, can be stored in the remote memory/storage device 746. It will be appreciated that the network connections shown are exemplary and other means of establishing a communications link between the computers can be used.

The computer 701 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

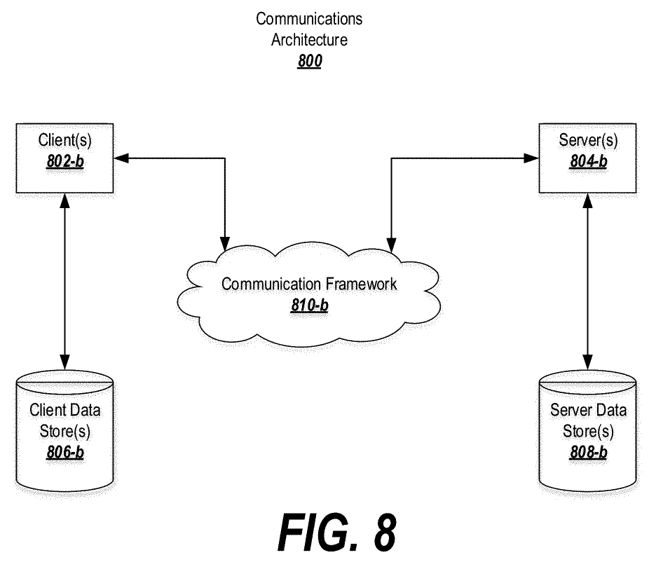

FIG. 8 is a block diagram depicting an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The clients 802 may implement the client device 510. The servers 804 may implement the server device 526. The clients 802 and the servers 804 are operatively connected to one or more respective client data stores 806 and server data stores 808 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.8a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

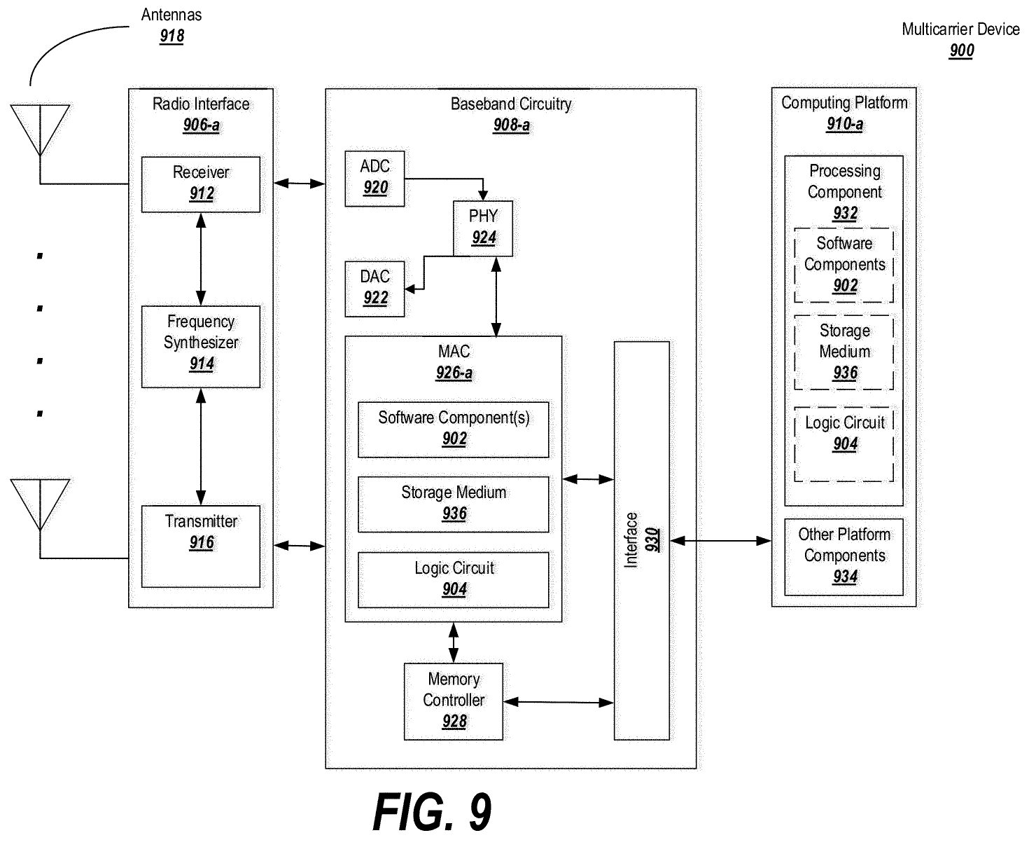

FIG. 9 illustrates an embodiment of a device 900 for use in a multicarrier OFDM system, such as the communication system 500. The device 900 may implement, for example, software components 902 as described with reference to the messaging component logic 600, the intent determination logic 700, and the group selection logic 800. The device 900 may also implement a logic circuit 904. The logic circuit 904 may include physical circuits to perform operations described for the messaging system 600. As shown in FIG. 9, device 900 may include a radio interface 906, baseband circuitry 908, and a computing platform 910, although embodiments are not limited to this configuration.

The device 900 may implement some or all of the structure and/or operations for the communication system 500 and/or logic circuit 904 in a single computing entity, such as entirely within a single device. Alternatively, the device 900 may distribute portions of the structure and/or operations for the messaging system 600 and/or logic circuit 904 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, the radio interface 906 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. The radio interface 906 may include, for example, a receiver 912, a transmitter 914 and/or a frequency synthesizer 916. The radio interface 906 may include bias controls, a crystal oscillator and/or one or more antennas 918. In another embodiment, the radio interface 906 may use external voltage-controlled oscillators (VCOs), surface acoustic wave filters, intermediate frequency (IF) filters and/or RF filters, as desired. Due to the variety of potential RF interface designs an expansive description thereof is omitted.

The baseband circuitry 908 may communicate with the radio interface 906 to process receive and/or transmit signals and may include, for example, an analog-to-digital converter 920 for down converting received signals, and a digital-to-analog converter 922 for up-converting signals for transmission. Further, the baseband circuitry 908 may include a baseband or physical layer (PHY) processing circuit 924 for PHY link layer processing of respective receive/transmit signals. The baseband circuitry 908 may include, for example, a processing circuit 926 for medium access control (MAC)/data link layer processing. The baseband circuitry 908 may include a memory controller 928 for communicating with the processing circuit 926 and/or a computing platform 910, for example, via one or more interfaces 930.

In some embodiments, the PHY processing circuit 924 may include a frame construction and/or detection module, in combination with additional circuitry such as a buffer memory, to construct and/or deconstruct communication frames, such as radio frames. Alternatively or in addition, the MAC processing circuit 926 may share processing for certain of these functions or perform these processes independent of the PHY processing circuit 924. In some embodiments, MAC and PHY processing may be integrated into a single circuit.

The computing platform 910 may provide computing functionality for the device 900. As shown, the computing platform 910 may include a processing component 932. In addition to, or alternatively of, the baseband circuitry 908, the device 900 may execute processing operations or logic for the communication system 500 and logic circuit 904 using the processing component 932. The processing component 932 (and/or the PHY 924 and/or MAC 926) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 910 may further include other platform components 934. Other platform components 934 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

The device 900 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of the device 900 described herein, may be included or omitted in various embodiments of the device 900, as suitably desired. In some embodiments, the device 900 may be configured to be compatible with protocols and frequencies associated one or more of the 3GPP LTE Specifications and/or IEEE 1402.16 Standards for WMANs, and/or other broadband wireless networks, cited herein, although the embodiments are not limited in this respect.

Embodiments of device 900 may be implemented using single input single output (SISO) architectures. However, certain implementations may include multiple antennas (e.g., antennas 918) for transmission and/or reception using adaptive antenna techniques for beamforming or spatial division multiple access (SDMA) and/or using MIMO communication techniques.

The components and features of the device 900 may be implemented using any combination of discrete circuitry, application specific integrated circuits (ASICs), logic gates and/or single chip architectures. Further, the features of the device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium 936 may include instructions that, when executed, cause a system to perform any of the computer-implemented methods described herein.

General Notes on Terminology

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A method comprising:
accessing a classification model, the classification model applying a parameter to classify an input;
applying an adversarial classifier to predict whether the input originated with the target group; and
adjusting the parameter of the classification model to render the adversarial classifier worse at predicting whether the input originated with the target group.

2. The method of claim 1, wherein a main classifier classifies the input based on the model and provides the classification to the adversarial classifier, the classification used by the adversarial classifier to predict whether the input originated with the target group.

3. The method of claim 1, wherein a main classifier classifies the input based on the model, and the classification model collapses to a cost function exposed to both the adversarial classifier and the main classifier.

4. The method of claim 1, wherein a decorrelator compares the prediction of the adversarial classifier to a label associated with the input to determine whether the adversarial classifier's prediction corresponds to the label.

5. The method of claim 1, wherein the applying and adjusting are repeated until a stopping condition is met, the stopping condition comprising one or more of:
the adversarial classifier becomes no better than chance at predicting whether the input originated with the target group, or
a prediction accuracy of the adversarial classifier's drops by more than a predetermined threshold amount after adjusting the parameter of the classification model.

6. The method of claim 1, wherein a main classifier classifies the input based on the classification model, and further comprising:
applying the classification model having the adjusted parameter to classify language with the main classifier as the language is generated,
determining that the language is classified in a target classification; and
generating an instruction for a display device to display a warning that the language may be classified in the target classification.

7. The method of claim 1, wherein a main classifier classifies the input based on the classification model, and further comprising:
applying the classification model having the adjusted parameter to classify pre-existing content,
determining that the content is classified in a target classification; and
flagging the pre-existing content for review.

8. A non-transitory computer-readable medium storing instructions that, when executed by one or more processors, cause the one or more processors to:
access a classification model, the classification model applying a parameter to classify an input;
apply an adversarial classifier to predict whether the input originated with the target group; and
adjust the parameter of the classification model to render the adversarial classifier worse at predicting whether the input originated with the target group.

9. The medium of claim 8, wherein a main classifier classifies the input based on the model and provides the classification to the adversarial classifier, the classification used by the adversarial classifier to predict whether the input originated with the target group.

10. The medium of claim 8, wherein a main classifier classifies the input based on the model, and the classification model collapses to a cost function exposed to both the adversarial classifier and the main classifier.

11. The medium of claim 8, wherein a decorrelator compares the prediction of the adversarial classifier to a label associated with the input to determine whether the adversarial classifier's prediction corresponds to the label.

12. The medium of claim 8, wherein the applying and adjusting are repeated until a stopping condition is met, the stopping condition comprising one or more of:
the adversarial classifier becomes no better than chance at predicting whether the input originated with the target group, or
a prediction accuracy of the adversarial classifier's drops by more than a predetermined threshold amount after adjusting the parameter of the classification model.

13. The medium of claim 8, wherein a main classifier classifies the input based on the classification model, and further storing instructions for:
applying the classification model having the adjusted parameter to classify language with the main classifier as the language is generated,
determining that the language is classified in a target classification; and
generating an instruction for a display device to display a warning that the language may be classified in the target classification.

14. The medium of claim 8, wherein a main classifier classifies the input based on the classification model, and further storing instructions for:
applying the classification model having the adjusted parameter to classify pre-existing content,
determining that the content is classified in a target classification; and
flagging the pre-existing content for review.

15. An apparatus comprising:
a non-transitory computer-readable medium configured to store a classification model, the classification model applying a parameter to classify an input;
a hardware processor circuit;
an adversarial classifier executable on the processor circuit to predict whether the input originated with the target group; and
a decorrelator executable on the processor circuit to adjust the parameter of the classification model to render the adversarial classifier worse at predicting whether the input originated with the target group.

16. The apparatus of claim 15, wherein a main classifier classifies the input based on the model and provides the classification to the adversarial classifier, the classification used by the adversarial classifier to predict whether the input originated with the target group.

17. The apparatus of claim 15, wherein a main classifier classifies the input based on the model, and the classification model collapses to a cost function exposed to both the adversarial classifier and the main classifier.

18. The apparatus of claim 15, wherein a decorrelator compares the prediction of the adversarial classifier to a label associated with the input to determine whether the adversarial classifier's prediction corresponds to the label.

19. The apparatus of claim 15, wherein the applying and adjusting are repeated until a stopping condition is met, the stopping condition comprising one or more of:
the adversarial classifier becomes no better than chance at predicting whether the input originated with the target group, or
a prediction accuracy of the adversarial classifier's drops by more than a predetermined threshold amount after adjusting the parameter of the classification model.

20. The apparatus of claim 15, wherein a main classifier classifies the input based on the classification model, and the processor circuit is further configured to:
apply the classification model having the adjusted parameter to classify language with the main classifier as the language is generated,
determine that the language is classified in a target classification; and
generate an instruction for a display device to display a warning that the language may be classified in the target classification.
